(19) United States
(12) Patent Application Publication
(10) Pub. No.: US 2021/0281629 A1
(43) Pub. Date: Sep. 9, 2021

(54) PROCESSING OF WEB-BASED APPLICATIONS

(71) Applicant: International Business Machines Corporation, Armonk, NY (US)

(72) Inventors: Chang Qing Zheng, Shanghai (CN); Gang Tian, Beijing (CN); Meng Xu, Beijing (CN); Qian Li, Tianjin (CN)

(21) Appl. No.: 16/809,763

(22) Filed: Mar. 5, 2020

(51) Int. Cl. H04L 29/08; G06Q 30/02; G06Q 30/04

(52) U.S. Cl. CPC H04L 67/02; H04L 67/10; G06Q 30/04; G06Q 30/0283

(57) ABSTRACT

Methods, apparatus, computer program products for improving performance of a web-based application are provided. The method comprises receiving, by one or more processing units, HTTP requests sent from the web-based application; selecting, by one or more processing units, some of the HTTP requests from the received HTTP requests; encapsulating, by one or more processing units, the selected HTTP requests into one or more data frames of a full-duplex communication protocol; and sending, by one or more processing units, the one or more data frames to a server that the web-based application is communication with via a communication channel established based on the full-duplex communication protocol.

### BACKGROUND

The present disclosure relates to network computing, and more specifically, to methods, systems and computer program products for performance improvement of web-based applications.

Web-based applications have seen a huge increase in popularity in recent years, replacing desktop applications and becoming a crucial instrument for small and large businesses around the world. Web-based applications are a particular type of software that allows users to interact with a remote server through a web browser interface. Web-based applications have a number of advantages over traditional desktop applications, most prominently their portability. With web-based applications, users don't have to install additional software, and developers don't have to write multiple versions of the same application for different operating systems. Web-based applications work on any device that can run a supported browser and has an active Internet connection.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment of the present disclosure, there is provided a method for improving the performance of a web-based application. HTTP requests sent from a client side of the web-based application are received and a plurality of HTTP requests are selected. Then the selected HTTP requests are encapsulated into one or more data frames of a full-duplex communication protocol. Then, the one or more data frames are sent to a server side of the web-based application that the client side of the web-based application is in communication with via a communication channel established based on the full-duplex communication protocol.

In one illustrative embodiment of the present disclosure, there is provided an apparatus for improving the performance of a web-based application. The apparatus comprises an HTTP handler, which is configured to receive HTTP requests sent from a client side of the web-based application and select some of the HTTP requests from the received HTTP requests; and a package converter, which configured to encapsulate the selected HTTP requests into one or more data frames of a full-duplex communication protocol and send the one or more data frames to a communication module. The one or more data frames are further sent to a server side of the web-based application that the client side of the web-based application is in communication with by the communication module via a communication channel established based on the full-duplex communication protocol.

Computer program products for improving the performance of a web-based application are also provided.

These and other features and advantages of the present disclosure will be described in, or will become apparent to those of ordinary skill in the art in view of, the following detailed description of the example embodiments of the present disclosure.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure:

FIG. 1 depicts a cloud computing node according to some embodiments of the present disclosure;

FIG. 2 depicts a cloud computing environment according to some embodiments of the present disclosure;

FIG. 3 depicts abstraction model layers according to some embodiments of the present disclosure;

FIG. 4 depicts a block diagram of an exemplary system in which embodiments of the disclosure may be implemented;

FIG. 5 depicts a flowchart of an exemplary method according to some embodiments of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Embodiments of the disclosure can be deployed on cloud computer systems which will be described in the following. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

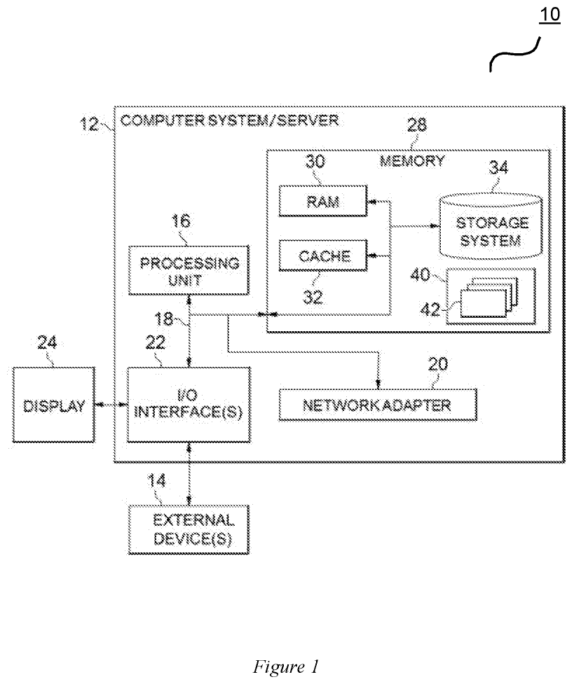

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

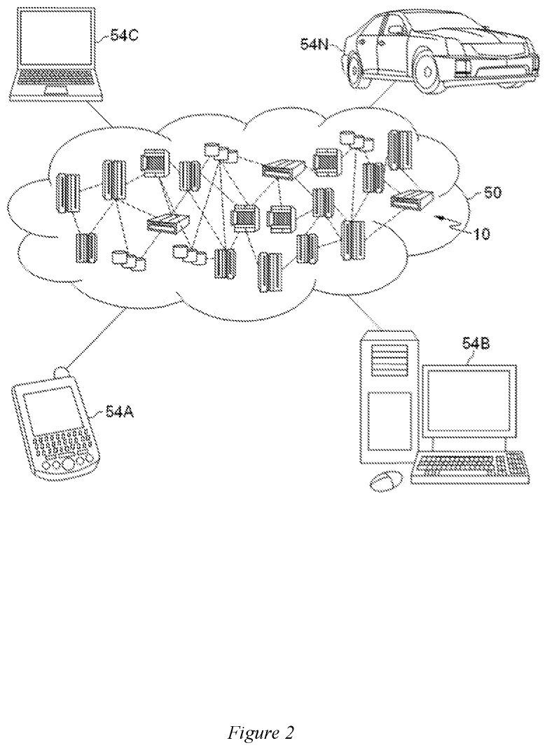

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

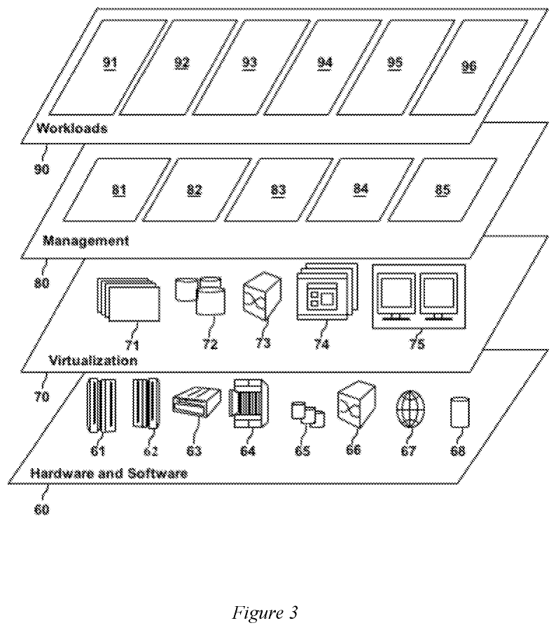

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and performance improvement processing 96 according to embodiments of the disclosure.

With more and more applications are shifting to be web-based, a design approach called Single-Page Architecture (SPA) has been developed where each new page's content is served not from loading new HTML pages but dynamically through e.g., JavaScript's ability to manipulate the Document Object Model (DOM) elements on the existing page itself. Applications designed using Single-Page Architecture are typically referred as single-page applications (SPAs). The two meanings may be interchangeable due to the respective abbreviations are the same. In the following of this disclosure, the term SPA will be used to represent the abbreviation for Single Page Application.

An SPA is a web application or web site which interacts with its user by dynamically rewriting the current page rather than loading entire new pages from a server. This approach avoids interruption of the user experience between successive pages, making the application behave more like a desktop application. In an SPA, either all necessary code—HTML, JavaScript, and CSS—is retrieved with a single page load, or the appropriate resources are dynamically loaded and added to the page as necessary, usually in response to user actions. The page does not reload at any point in the process, nor does control transfer to another page. Interaction with the SPA often involves dynamic communication behind the scenes—typically between a component that is responsible for its data handling (with a server) and the web server—by way of HTTP (Hypertext Transfer Protocol) requests and responses.

In the event that a plurality of components co-exist in an SPA, high concurrent requests may occur from a web browser in communication with its server. This may result in deterioration of performance, due to the fact that each HTTP request is processed in a single thread in the design of modern browser architecture, and high concurrent HTTP requests will consume a lot of system resources. Typically, a browser limit the maximum number of concurrent HTTP requests (e.g., 4-6 HTTP requests) that may be handled at the same time and other concurrent HTTP requests that exceed the limit will need to enqueue and wait to be scheduled. As a result, HTTP request/response cycle will be enlarged, which leads to further deterioration of performance and bad user experience.

Embodiments of the disclosure can improve the performance of a web-based application discussed in the above. In the following of this disclosure, embodiments of the disclosure will be discussed with an SPA as an example of the web-based application, however, it should be pointed out that the disclosure in question is applicable to all types of web-based applications that may issue high concurrent HTTP requests and is not limited to SPA.

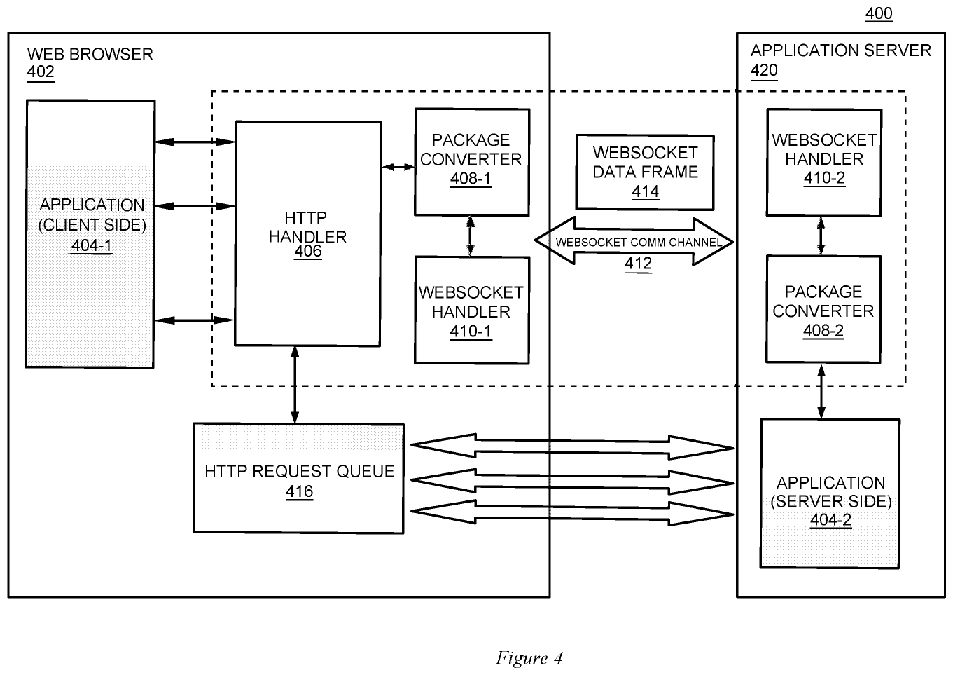

Referring now to FIG. 4, which depicts a system 400 in which embodiments of the disclosure may be implemented. The system 400 may be a client/server system with web browser 402 as the client. Inside the web browser 402, a web-based application 404, e.g., a client-side 404-1 of the application according to some embodiments of the disclosure, may be running. An application server 420 with a server-side 404-2 of the application running inside it is as the server of the system 400 and is accessible by the client-side 404-1 of the application by way of the web browser 402 via a network connection, typically the Internet. The web browser 402 may be any types of browsers, e.g., Google Chrome® browser, Mozilla® Firefox® browser, Apple® Safari® browser, etc. The communication between the web browser 402 and the application server 420 may utilize any types of communication protocols supported by the web browser 402, e.g., HTTP (Hypertext Transfer Protocol), TLS (Transport Layer Security), Secure Socket Layer (SSL), File Transfer Protocol (FTP), etc.

The application server 420 may be any type of application servers applicable to host the server-side 404-2 of the application, for example, a physical server or a virtual server with necessary resources installed and pre-configured thereon. The application server 420 receives requests from the client-side 404-1 of the application, processes them (e.g. by way of accessing associated resources) and returns requested resources in corresponding responses to respective requests.

An HTTP request queue 416 in the web browser 402 is also shown in FIG. 4, which enqueues all HTTP requests that exceed the maximum number of concurrent HTTP requests allowed by the web browser 402 from the client-side 404-1 of the application. For example, if the number of concurrent HTTP requests from the client-side 404-1 of the application is 15 (with corresponding sequence numbers from 1 to 15), and the maximum number of concurrent HTTP requests allowed by the web browser 402 is 6 (with corresponding sequence numbers from 1 to 6), the HTTP requests with sequence numbers from 7 to 15 will be enqueued in the HTTP request queue 416. Only after a response to a certain previous request (e.g., the HTTP request with sequence number 3) has been returned from the application server 420 will a following HTTP request in the HTTP request queue 416 be sent to the application server 420 for processing.

Also shown in FIG. 4, a WebSocket handler 410-1 in the web browser 402 and a corresponding WebSocket handler 410-2 in the application server 420 are responsible for exchanging data via a WebSocket communication channel 412 therein between. It should be pointed out that in the disclosure, WebSocket is merely as an example of the full-duplex communication protocol utilized by the web browser 402 and the application server 420. Although in the disclosure, embodiments of the disclosure are discussed with WebSocket as the communication protocol, however, any other full-duplex communication protocols existing nowadays or developed in the future may be utilized and therefore should not adversely limit the scope of the disclosure. WebSocket is a computer communications protocol supported by most modern web browsers, providing full-duplex communication channels over a single TCP (Transmission Control Protocol) connection. The WebSocket protocol was standardized by the Internet Engineering Task Force (IETF) as Request for Comments (RFC) 6455, which is incorporated herein by reference. The WebSocket protocol enables interaction between a web browser (or other client application) and a web server with lower overhead than half-duplex alternatives such as HTTP polling, facilitating real-time data transfer from and to the server. This is made possible by providing a standardized way for the server to send content to the client without being first requested by the client and allowing messages to be passed back and forth while keeping the connection open. In this way, a two-way ongoing conversation can take place between the client and the server. Embodiments of the disclosure can take advantage of the aforementioned merits of the dull-duplex communication protocol.

The web browser 402, the client-side 404-1 of the application, the server-side 404-2 of the application, the HTTP request queue 416, and the WebSocket handler 408-1 and 408-2 may be the same as those in prior arts. To better address the problems discussed in the above, modifications to the web browser 402, for example, in the form of an extension according to some embodiments of the disclosure are shown in FIG. 4.

The extension to the web browser 402 includes an HTTP handler 406 and a package converter 408-1, as shown in FIG. 4. The HTTP handler 406 is configured to receive HTTP requests sent from the client-side 404-1 of the application and select a plurality of HTTP requests from the received HTTP requests. The package converter 408-1 is configured to encapsulate the plurality of HTTP requests selected by the HTTP handler 406 into one or more data frames according to a full-duplex communication protocol utilized by the web browser 402 and the application server 420, e.g., the WebSocket communication protocol. The package converter 408-1 is further configured to send the one or more data frames with the plurality of the HTTP requests encapsulated within to the WebSocket handler 410-1, which are further sent to the application server 420. The package converter 408-1 is further configured to receive one or more further data frames returned from the application server 420 via the WebSocket handler 410-2 and de-encapsulates respective HTTP responses to the plurality of the HTTP requests from the one or more further data frames. The package converter 408-1 is further configured to send the respective HTTP responses to the client-side 404-1 of the application as respective responses to the plurality of the HTTP requests via the WebSocket handler 410-1. The HTTP handler 406 is further configured to send those HTTP requests which are not selected to the HTTP requests queue 416. It should be pointed out, the term ‘data frame’ may refer to data packages of any type, depending on the full-duplex communication protocol actually adopted.

During an initialization process of an HTTP communication with the application server 420, the client-side 404-1 of the application sends a handshake HTTP request via the web browser 402 to the application server 420 to establish a communication channel according to a full-duplex communication protocol, e.g., the WebSocket protocol. The handshake HTTP request may be, for instance, in the following format, with the WebSocket protocol as an example (it should be noted, the handshake HTTP request to establish a communication channel may be different, subject to the actual communication protocol):

GET/httpwrap HTTP/1.1

Host: server.example.com

Upgrade: websocket

Connection: Upgrade

Sec-WebSocket-Key: dGhlIHNhbXBsZSBub25jZQ==

Origin: http://example.com

The application server 420 returns a response to the handshake HTTP request in the following format to the client-side 404-1 of the application, and therefore the WebSocket communication channel 412 will be established between the client-side 404-1 of the application (via the web browser 402) and the application server 420, if the application server 420 supports a WebSocket connection:

HTTP/1.1 Switching Protocols

Upgrade: websocket

Connection: Upgrade

Sec-WebSocket-Accept: s3pPLMBiTxaQ9kYGzzhZRbK+xOo=

All HTTP requests sent from the client-side 404-1 of the application requesting resources from the application server 420 are received by the HTTP handler 406, in other words, the HTTP handler 406 intercepts all HTTP communication between the client-side 404-1 of the application and the application server 420 and selects a plurality of HTTP requests from the received HTTP requests to be encapsulated into one or more data frames according to the WebSocket protocol in order that they could be transferred via the WebSocket communication channel 412. According to some embodiments of the disclosure, only dynamic HTTP requests are selected to be encapsulated into the one or more data frames. Static HTTP requests will be sent by the HTTP handler 406 to the HTTP request queue 416 and gone through HTTP channel (the three parallel two-way arrows shown in the lower part of FIG. 4) same as current HTTP mechanisms. According to some embodiments of the disclosure, dynamic HTTP requests refer to those HTTP requests for the results generated by server-side 404-2 of application hosted on the application server 420, while static HTTP requests refer to those HTTP requests for static resources, e.g., a plain text file, an image, a script file, and etc. Typically, static resources are stored on the application server 420 (or other servers connected directly or indirectly to the application server 420) as files. According to some embodiments of the disclosure, whether an HTTP request is a dynamic or static one may be simply identified from MIME-TYPE header (e.g. application/json) of the HTTP request. According to another embodiment of the disclosure, a blacklist or a whitelist may be used to define what specific HTTP requests are denied or allowed to go through the WebSocket communication channel 412. Alternatively, a priority property may be added to the client-side 404-1 of the application during the development of the application, such that only HTTP requests with corresponding priority above a certain threshold will go through the WebSocket communication channel 412 in its production environment.

Then, the plurality of HTTP requests selected by the HTTP handler 406 are passed to the package converter 408-1 and encapsulated into the one or more data frames of the WebSocket protocol. In the following Table 1, it is illustrated a WebSocket data frame according to Section 5.1 of the aforementioned WebSocket protocol as set forth in IETF RFC 6455.

According to the WebSocket protocol, as shown in Table 1, the first byte (bit 0-7), which comprises the following data fields: FIN, RSV1, RSV2, RSV3 and Opcode, indicates the type of the frame. The second byte (bit 8-15) indicates the length of the payload. The bytes following the second byte carry the actual payload, in which the plurality of HTTP requests selected by the HTTP handler 406 will be encapsulated into. The detailed meaning of each data field may be referenced in the in IETF RFC 6455.

For example, if one of the selected HTTP requests is shown as following, the whole HTTP request (all three lines) will be encapsulated into the payload shown above with related data fields modified. According to some embodiments of the disclosure, each of the plurality of HTTP requests selected may be encapsulated into one corresponding WebSocket data frame, or more than one HTTP request of the plurality of HTTP requests selected may be encapsulated into one WebSocket data frame.

GET/status HTTP/1.1

Host: www.datacenter.com

Accept: application/json

Then the one or more WebSocket data frames with the plurality of HTTP requests selected encapsulated within will be passed to the WebSocket handler 410-1 and further sent to the application server 420 via the WebSocket communication channel 412.

The WebSocket handler 410-2 residing in the application 420 receives the one or more data frames sent from the web browser 402 (by the WebSocket handler 410-1 via the WebSocket communication channel 412) and passes them to the package converter 408-2 where the plurality of HTTP requests selected will be de-encapsulated and sent to the server-side 404-2 of the application. The server-side 404-2 of the application processes the plurality of HTTP requests and returns respective HTTP responses to the plurality of HTTP requests and sends them to the package converter 408-2, where the respective HTTP responses to the plurality of HTTP requests are encapsulated into one or more further WebSocket data frames. The encapsulation process is similar to the encapsulation process of the plurality of HTTP requests. Then the one or more further WebSocket data frames are passed to the WebSocket handler 410-2 and further sent back to the web browser 402 via the WebSocket communication channel 412 by way of the WebSocket hander 410-1. The one or more further WebSocket data frames are then passed to the package converter 408-1, where the respective HTTP responses to the plurality of HTTP requests are de-encapsulated and further sent to the client-side 404-1 of the application via the HTTP handler 406, as respective responses to the plurality of the HTTP requests.

Those HTTP requests not selected by the HTTP handler 406 will be sent to the HTTP request queue 416 and gone through HTTP channel (the three parallel two-way arrows shown in the lower part of FIG. 4) same as current HTTP mechanisms.

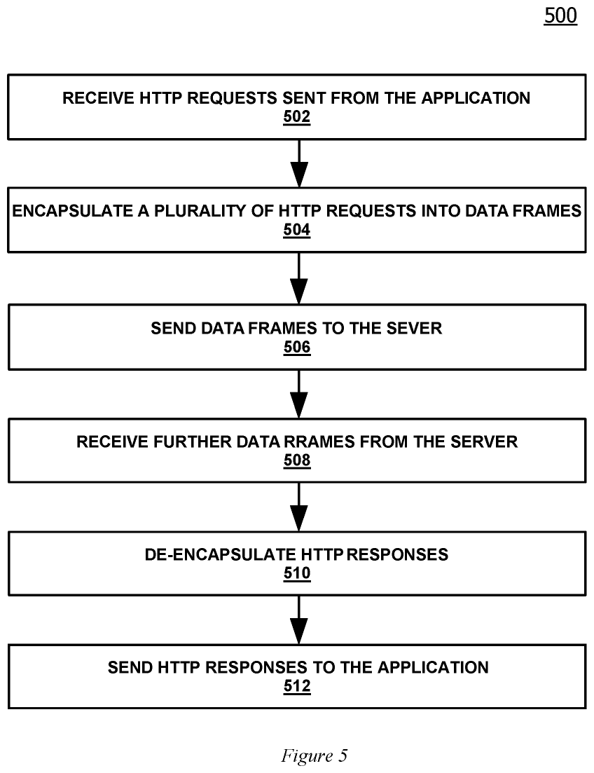

Referring now to FIG. 5, which depicts a flowchart of an exemplary method 500 for improving performance of a web-based application according to some embodiments of the disclosure. At step 502 of method 500, HTTP requests sent from a client side of the web-based application (for example, the client-side 404-1 of FIG. 4) are received and a plurality of HTTP requests is selected from the received HTTP requests (for example, by the HTTP handler 406 of FIG. 4). According to some embodiments of the disclosure, the plurality of HTTP requests selected is dynamic HTTP requests. Then at step 504, the plurality of HTTP requests is encapsulated (for example, by the package converter 408-1 of FIG. 4) into one or more data frames of a full-duplex communication protocol (for example, the WebSocket protocol) and sent, at step 506 to a server side (for example, the server side 404-2 of the web-based application in FIG. 4) of the web-based application that the client side of the web-based application is in communication with via a communication channel (for example, the WebSocket communication channel 412) established based on the full-duplex communication protocol.

Then, at step 508, according to some embodiments of the disclosure, method 500 further receives one or more further data frames (for example, by way of the WebSocket handler 410-1 of FIG. 4) from the server side of the web-based application via the communication channel, wherein respective HTTP responses to the plurality of HTTP requests are encapsulated within the one or more further data frames. Then, at step 510, the respective HTTP responses to the plurality of HTTP requests are de-encapsulated (for example, by the package converter 408-1 of FIG. 4) from the one or more further data frames and sent to the client side of the web-based application as respective responses to the plurality of HTTP requests at step 512.

According to some embodiments of the disclosure, the communication channel is established responsive to an initialization process of an HTTP communication with the server.

According to some embodiments of the disclosure, the plurality of HTTP requests selected are dynamic HTTP requests.

According to some embodiments of the disclosure, the web-based application is a single page application.

It should be noted that the performance improvement processing according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving, by one or more processing units, a plurality of HTTP requests sent from a client side of a web-based application, wherein:
a first portion of the plurality of HTTP requests are dynamic-type HTTP requests for dynamic-type resources; and
a second portion of the plurality of HTTP requests are static-type HTTP requests for static-type resources;
selecting, by one or more processing units, some of the plurality of HTTP requests from the received HTTP requests based on a type of data being sought by a given HTTP request;
encapsulating, by one or more processing units, the selected some of the plurality of HTTP requests into one or more data frames of a full-duplex communication protocol; and
sending, by one or more processing units, the one or more data frames to a server side of the web-based application that the client side of the web-based application is in communication with via a communication channel established based on the full-duplex communication protocol;
wherein the dynamic-type resources and the static-type resources are stored on a same server; and
wherein responses to the dynamic-type HTTP requests and to the static-type HTTP requests are generated by the same server.

2. The computer-implemented method of claim 1, further comprising:
receiving, by one or more processing units, one or more further data frames from the server side of the web-based application via the communication channel, wherein respective HTTP responses to the selected some of the plurality of HTTP requests are encapsulated in the one or more further data frames.

3. The computer-implemented method of claim 2, further comprising:
de-encapsulating, by one or more processing units, the respective HTTP responses to the selected some of the plurality of HTTP requests from the one or more further data frames.

4. The computer-implemented method of claim 3, further comprising:
sending, by one or more processing units, the respective HTTP responses to the client side of the web-based application as respective responses to the selected some of the plurality of HTTP requests.

5. The computer-implemented method of claim 1, wherein the communication channel is established in response to an initialization process of an HTTP communication between the client side of the web-based application with the server side of the web-based application, wherein the initialization process comprises:
sending, by one or more processing units, a handshake HTTP request to the server side of the web-based application; and
receiving, by one or more processing units, a response to the handshake HTTP request from the server side of the web-based application via the communication channel.

6. The computer-implemented method of claim 1, wherein the selected some of the plurality of HTTP requests are dynamic-type HTTP requests, and the selected some of the plurality of HTTP requests are not static-type HTTP requests.

7. The computer-implemented method of claim 1, wherein the web-based application is a single page application.

8. A computer-implemented apparatus, comprising:
an HTTP handler, configured to receive a plurality of HTTP requests sent from a client side of a web-based application and selected HTTP requests selected from the received plurality of HTTP requests having been selected based on a type of data being sought by a given HTTP request, wherein:
a first portion of the plurality of HTTP requests are dynamic-type HTTP requests for dynamic-type resources; and
a second portion of the plurality of HTTP requests are static-type HTTP requests for static-type resources;
a package converter, configured to encapsulate the selected HTTP requests into one or more data frames of a full-duplex communication protocol and send the one or more data frames to a communication module,
wherein the one or more data frames are further sent to a server side of the web-based application that the client side of the web-based application is in communication with by the communication module via a communication channel established based on the full-duplex communication protocol;
wherein the dynamic-type resources and the static-type resources are stored on a same server; and
wherein responses to the dynamic-type HTTP requests and to the static-type HTTP requests are generated by the same server.

9. The computer-implemented apparatus of claim 8, wherein the package converter is further configured to receive one or more further data frames via the communication module from the server side of the web-based application via the communication channel, wherein respective HTTP responses to the selected HTTP requests are encapsulated in the one or more further data frames.

10. The computer-implemented apparatus of claim 9, wherein the package converter is further configured to de-encapsulate the respective HTTP responses to the plurality of HTTP requests from the one or more further data frames.

11. The computer-implemented apparatus of claim 10, wherein the package converter is further configured to send, via the HTTP handler, the respective HTTP responses to the client side of the web-based application as respective responses to the selected HTTP requests.

12. The computer-implemented apparatus of claim 8, wherein the communication channel is established responsive to an initialization process of an HTTP communication between the client side of the web-based application with the server side of the web-based application, wherein the client side of the web-based application is configured to:
send a handshake HTTP request to the server side of the web-based application; and
receive a response to the handshake HTTP request from the server side of the web-based application via the communication channel.

13. The computer-implemented apparatus of claim 8, wherein the selected HTTP requests are dynamic-type HTTP requests, and the selected HTTP requests are not static-type HTTP requests.

14. The computer-implemented apparatus of claim 8, wherein the web-based application is a single page application.

15. A computer program product, comprising a non-transitory computer readable storage having program codes embodied therewith, the program codes comprising:
program codes to receive HTTP requests sent from a client side of a web-based application, wherein:
a first portion of the plurality of HTTP requests are dynamic-type HTTP requests for dynamic-type resources; and
a second portion of the plurality of HTTP requests are static-type HTTP requests for static-type resources;
program codes to select a portion of the HTTP requests from the received HTTP requests based on a type of data being sought by a given HTTP request;
program codes to encapsulate the portion of the HTTP requests into one or more data frames of a full-duplex communication protocol; and
program codes to send the one or more data frames to a communication module wherein the one or more data frames are further sent to a server side of the web-based application that the client side of the web-based application is in communication with by the communication module via a communication channel established based on the full-duplex communication protocol,.
wherein the dynamic-type resources and the static-type resources are stored on a same server; and
wherein responses to the dynamic-type HTTP requests and to the static-type HTTP requests are generated by the same server.

16. The computer program product of claim 15, further comprising program codes to receive one or more further data frames via the communication module from the server side of the web-based application via the communication channel, wherein respective HTTP responses to the portion of the HTTP requests are encapsulated in the one or more further data frames.

17. The computer program product of claim 16, further comprising program codes to de-encapsulate the respective HTTP responses to the portion of the HTTP requests from the one or more further data frames.

18. The computer program product of claim 17, further comprising program codes to send the respective HTTP responses to the client side of the web-based application as respective responses to the portion of the HTTP requests.

19. The computer program product of claim 15, wherein the communication channel is established responsive to an initialization process of an HTTP communication between the client side of the web-based application with the server side of the web-based application, wherein the program codes further comprise:
program codes to receive a handshake HTTP request from the client side of the web-based application; and
program codes to send a response to the handshake HTTP request to the client side of the web-based application via the communication channel.

20. The computer program product of claim 15, wherein the portion of the HTTP requests selected are dynamic-type HTTP requests, and the portion of the HTTP requests selected are not static-type HTTP requests.
